(19) United States
(12) Patent Application Publication
(10) Pub. No.: US 2025/0163738 A1
(43) Pub. Date: May 22, 2025

(54) Low Profile Double Link Hinge

(71) Applicant: Takehiro Murao, New York, NY (US)

(72) Inventor: Takehiro Murao, New York, NY (US)

(21) Appl. No.: 18/518,417

(22) Filed: Nov. 22, 2023

(51) Int. Cl. E05D 3/14

(52) U.S. Cl. CPC E05D 3/14

(57) ABSTRACT

A double-link hinge is provided, which can smoothly transition between an open state and a closed state with a net relative rotation of 90° of the objects linked via the hinge. The objects linked by the hinge also execute a relative translation during the transition. When used to mount a door, a hinge of the invention causes the door to sweep out a smaller area than a door of the same width would sweep out if attached to conventional hinges, due to the simultaneous translation of the door relative to the door frame. A hinge of the invention has a very low profile on the surface of the door.

### RELATED APPLICATIONS

There are no related applications.

### FIELD OF THE INVENTION

The present invention relates to hinges, and in particular to double-link hinges enabling simultaneous relative rotation and translation of the linked components.

### BACKGROUND

Conventional swinging door hinges typically combine a single hinge pin holding together a stationary plate and a swinging plate. The pin is trapped between knuckles formed into the edges of the plates, enabling the plates to rotate relative to one another about the axis of the pin. A door hung on such a hinge sweeps out a circular arc, centered on the pin axis, as it swings open and closed.

Hinges that employ quadrilateral linkages, wherein the stationary and swinging plate are rotatably connected to two arms attached at four pivot points, have long been known, and enable combined rotational and translational motion of the linked parts. By way of example, the chest hinge disclosed in U.S. Pat. No. 2,355,542, and the refrigerator door hinge disclosed in U.S. Pat. No. 5,497,534, confer to the door a combined rotation-translation motion similar to that of the present invention. These prior art hinges provide only a limited amount of translational motion, intended to prevent binding or interference between the door and frame, and a door mounted on such a hinge will still sweep out substantially the same arc as it would on a simple hinge.

The arc swept out by an architectural door mounted on the above-described prior art hinges (the “door swing area”) appropriates floor space that is rendered unavailable for other purposes. Where floor space is highly valuable, as it is in urban retail and residential buildings, it would be desirable to reclaim as much of that space as possible. Even where the floor space is little used, as it is for example in stairwell landings, there are building codes (e.g., NFPA code 101B) that specify the maximum encroachment of swinging doors into egress areas. A door that produces less encroachment when swung open can reduce the mandated size of stair landings, and enable an architect to create more usable interior space while adhering to the applicable code. Small apartments, commercial aircraft, boats and ships, and tight spaces in general, can benefit from doors having a reduced door swing area and less encroachment. Very wide doors, as found in performance spaces, industrial buildings and hospital corridors, would also benefit greatly from a reduced door swing area.

There is a need for door hinge mechanisms that reduce or minimize door swing area and/or encroachment. The present invention provides a hinge that meets this need, and is suitable for use in a variety of space-constrained applications.

### SUMMARY OF THE INVENTION

The present invention provides a four-pivot hinge comprising a frame plate (“stationary plate”) that is fixed to a stationary object, such as a wall or door frame, and a door plate (“swinging plate”) that is fixed to, and preferably parallel to the plane of, an affixed movable object, such as a door. For convenience, the terms “wall”, “frame”, “jamb” and “door” will be used to refer to the objects movably connected via the hinge, but it should be understood that the invention is not limited to this specific architectural application.

The stationary plate and swinging plate are connected via at least one short linkage arm and at least one long linkage arm, each end of which is pivotably coupled to one of the plates at parallel but not co-axial (i.e. offset) pivots. A door mounted on such a hinge assembly will open with a combination of rotation and translation, in which the door translates away from the direction in which it is being swung open. The resulting sweep area of the door may be about half of what it would be if the door were mounted on conventional hinges. The particular embodiment illustrated herein combines a very low profile with considerable weight-bearing ability, and will be attractive to interior designers for its aesthetics and for its suitability for use with glass doors.

For a better understanding of the invention, its mode of operation, and its advantages, reference should be made to the drawings and detailed description which follow.

### BRIEF DESCRIPTION OF THE DRAWINGS

FIGS. 1 and 2 are different perspective views of a hinge assembly of the invention, in which the stationary plate and swinging plate are at a 90° angle.

FIGS. 3 and 4 are different perspective views of a hinge assembly of the invention, in which the stationary plate and swinging plate are at a 45° angle.

FIG. 5 is a perspective view of a hinge assembly of the invention, in which the stationary plate and swinging plate are in parallel planes.

FIG. 6 is a partial perspective view, from the opposite side, of the hinge assembly shown in FIG. 5.

FIG. 7 is an overhead view of a door, mounted on a hinge assembly of the invention, in its closed position, with the hinge assemblies being mounted on a door frame.

FIG. 8 is an overhead view of the door of FIG. 7, in a partially-open position.

FIG. 9 is an overhead view of the door of FIG. 7, in the fully-open position.

FIG. 10 shows the door swing area (A) swept out by a door mounted on a hinge assembly of the invention, together with the area (B) swept out by the same door if mounted on conventional hinges.

FIG. 11 illustrates the mathematically-related linkage arm lengths and hinge axis offsets in a first embodiment of the invention.

FIG. 12 shows the embodiment of FIG. 11, with the additional feature of stops that limit rotation to the desired range of motion.

FIG. 13 is a perspective view of a second embodiment of the invention.

FIG. 14 illustrates the mathematically-related linkage arm lengths and hinge axis offsets in a third embodiment of the invention.

FIG. 15 illustrates a door hung on a frame with three hinges of the invention, having a guide pin riding within a track in the header of the frame.

### DETAILED DESCRIPTION OF THE INVENTION

In the following description of preferred embodiments of the present invention, reference is made to the accompanying drawings, which show specific representative embodiments of the invention as an aid to understanding. Those skilled in the art will recognize that variations in proportions and materials, and substitutions of equivalent elements, may be made without departing from the spirit and scope of the present invention, so long as the specified mathematical relationships are satisfied.

For convenience, and as an aid to clarity in describing the invention, the terms “stationary plate” and “swinging plate” have been assigned to the two plates of the hinge of the invention as illustrated herein, and the terms “open state” and “closed state” have been assigned to two configurations of the hinge as illustrated. It should be appreciated that the motion of either plate is relative to the other plate, and that in practice the roles of the two plates can be exchanged, i.e., the plate that is labeled “stationary” in the illustrated embodiments can be affixed to a door, and the plate labeled “swinging” can be affixed to a wall or door frame. Each of the claim terms “first plate” and “second plate” should accordingly be understood to encompass the stationary and swinging plate components of the hinge. Furthermore, the states identified herein as “open” and “closed” may be interchanged by affixing one of the plates at a 90° angle to the orientation shown in the illustrations. All such embodiments are contemplated to be within the scope of the invention.

The term “plate” broadly encompasses any shape configured to be readily affixed to a door or door frame, when a hinge is to be used architecturally. This generally calls for screw or bolt holes, but the invention does not require any specific attachment means; any means that is appropriate for a given application can be employed. By way of example, riveting may be used where the plate is to be attached to sheet metal, and welding or adhesives may be appropriate in some applications. Plates for such applications are preferably planar, or comprise a planar portion that is suitable for and sized for attachment to planar doors and planar surfaces in a door frame. Non-planar surfaces may require correspondingly non-planar plates. Injection molding can be used to simultaneously form both a living hinge and the object or objects that require the hinge; in such cases the term “plate” should be understood to effectively encompass the attached objects, such as a container and a lid.

For clarity, the term “pivot” will be used to refer to any of the individual pivoting means (e.g., two knuckles joined by an axial pin) that rotatably couple the linkage arms to the plates, while the term “hinge” will refer to the overall assembly of plates and linkage arms that constitute a device of the invention. The term “pivot axis” refers to the imaginary line around which the pivoting elements rotate; a pivot axis should be understood to be a line in space that extends beyond the physical pivoting means. Distances between parallel pivot axes are measured perpendicular to these lines.

The means of rotatably coupling the linkage arms to the plates is preferably a conventional pin-and-knuckle construction, examples of which is shown in the drawings. The linkage arms and their terminal knuckles, as well as the plates and their knuckles, are preferably monolithic objects, and may be formed by any method known in the art, including but not limited to 3-D printing (additive manufacturing), machining, and sheet metal bending (e.g. with a punch press, press brake, stamping tool, etc.) Smaller examples may be molded from polymer, and may optionally feature an integral continuous or bistable (e.g. butterfly) “living hinge”. Alternatively, separate pivoting means may be attached to the plates and linkage arms, and include but are not limited to plain, ball bearing, rising, and spring-loaded butt hinges; concealed hinges, piano hinges, and the like.

The pivot axes are all parallel, but are offset from one another, defining four different axes of rotation. In the first embodiment shown in the drawings and described in detail below, the two pivot axes associated with the stationary plate are set in a plane perpendicular to the plate, while the two pivot axes associated with the swinging plate are set in a plane parallel to that plate. The distance between the pivot axes at the stationary plate is larger than the distance between pivot axes at the swinging plate. Viewed in cross section, the four pivot axes define the corners of an elongated quadrilateral having four unequal sides. In operation of this embodiment of the hinge, all four interior angles of the quadrilateral change as the hinge transitions from the open state to the closed state, and the quadrilateral collapses to a line as the hinge reaches either of these configurations.

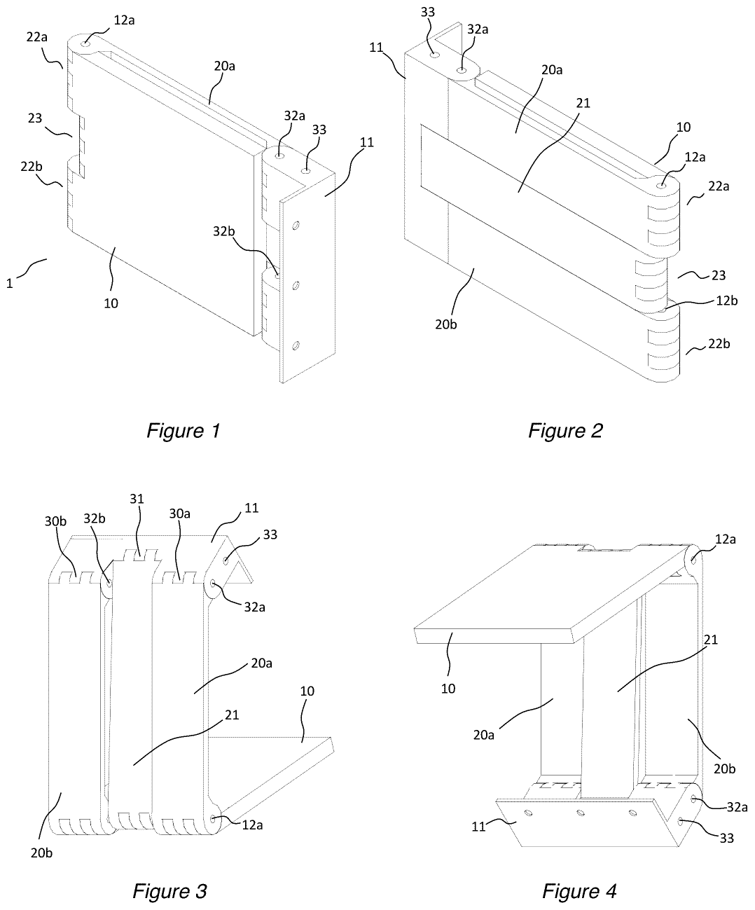

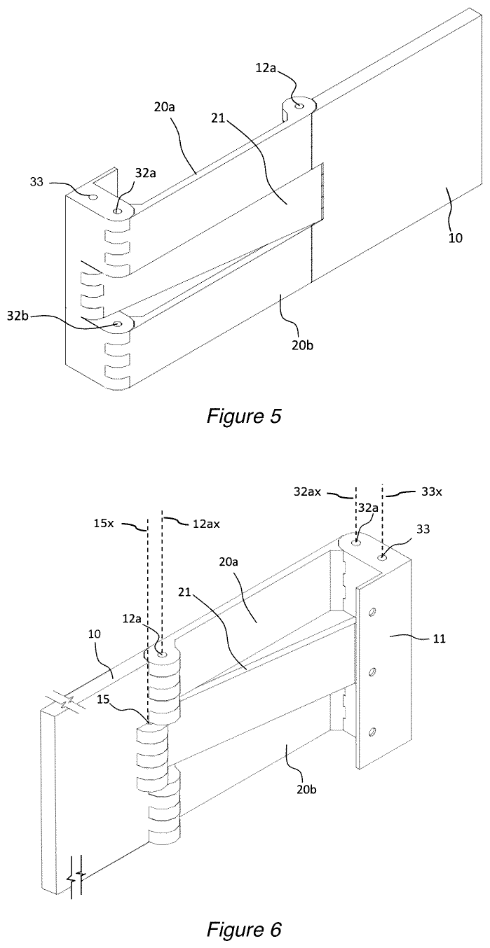

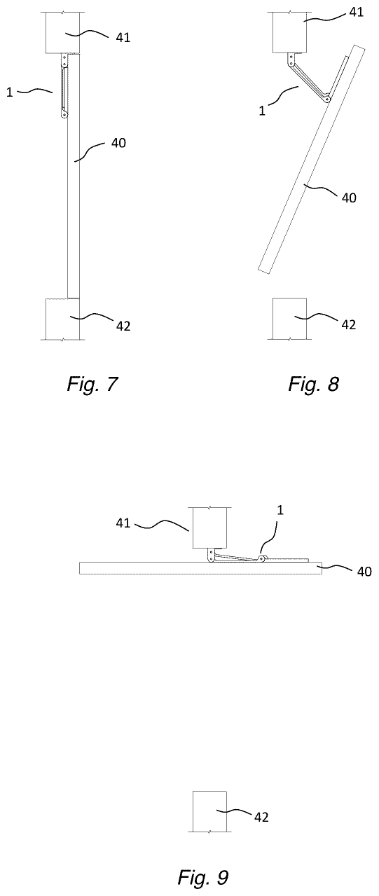

In the first embodiment shown, as the hinge approaches the closed state, two opposing angles of the quadrilateral approach 0° as the other two approach 180°, thereby collapsing the quadrilateral to a straight line. This results in a folded, flat configuration (FIGS. 1 and 2) that occupies very little space and has minimal protrusion from the door, and which can even be recessed into the door if desired. In this configuration, the door is held perpendicular to the wall (FIG. 7). As the hinge approaches the open state, one of the two adjacent angles associated with the stationary plate approaches 90°, while those associated with the swinging plate approach 180° (FIGS. 5 and 6), again collapsing the quadrilateral to a straight line and bringing the door parallel to the wall (FIG. 9).

The ability to achieve the open and closed states, and a smooth transition through the intermediate configurations that lead from one to the other, are enabled by particular mathematical relationships between the linkage arm lengths and the relative positions of the pivot axes at the plates. For the first embodiment (FIGS. 1-6) of a hinge capable of a 90° rotation of the swinging plate relative to the fixed plate, two equations must be satisfied:

a=(y cos(sin⁻¹(b/y))−(y−b))/2 (Eqn. 1)

x=(y−b)+a (Eqn. 2)

(Alternative embodiments will employ alternative equations, as set out further below.)

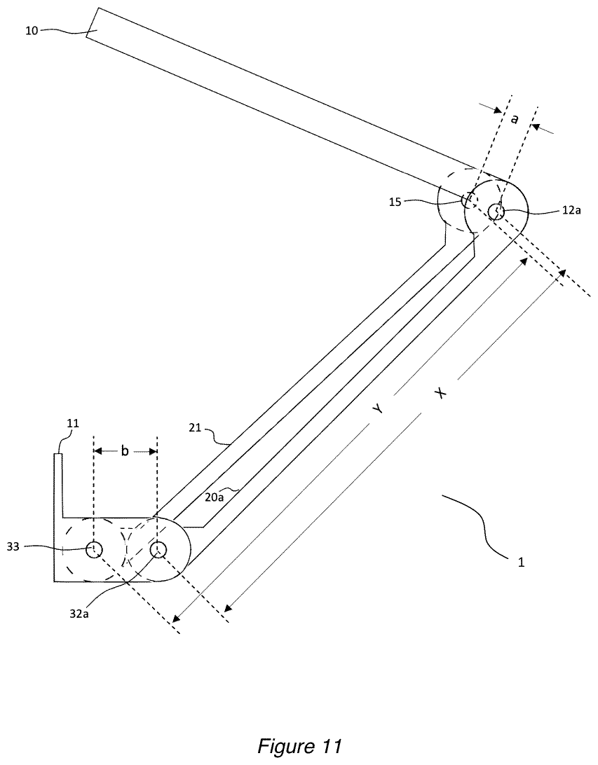

So long as the dimensions a, b, x and y, as shown in FIG. 11, satisfy both of the above formulas, a hinge of the invention, constructed with those dimensions, will satisfactorily open and close over a range of 90°. Selection of any two of these four dimensions establishes specific values for the other two. By way of example, if the length y of the long linkage arm is 8.000 inches, and the axis spacing b is 1.000 inch, then axis spacing a will be 0.4686 inches and the length x of the short linkage arm will be 7.4686 inches, to the nearest ten thousandth of an inch. Minor deviations from the calculated values are permissible, given some degree of flexibility of the components and backlash in the pivots. The use of more rigid components and precision hinges will require closer adherence to the calculated values, and manufacturing tolerances may need to be tightened accordingly.

Referring now to the drawings, FIGS. 1 and 2 show two perspective views of a representative hinge 1 of the invention, in the “closed” configuration. A swinging plate 10 is formed at one edge into the knuckles of at least two pin-and-knuckle pivots 22a and 23, the axial pins of which (15 and 21a) are arranged on parallel pivot axes 15x and 12ax (see FIG. 6.) The pivot axes of pins 12a and 15 (not visible; see FIG. 6) are separated by a distance a as illustrated in FIG. 11. The preferred embodiment shown incorporates a third pin-and-knuckle pivot 22b, having a parallel axial pin 12b. Alternative embodiments may incorporate four or more pin-and-knuckle pivots, alternating in their offset positions, and correspondingly four or more alternating long (21) and short (20a, 20b) linkage arms. The use of integral pin-and-knuckle pivots, as shown in the drawings, is preferred, but any type of pivots may be employed so long as their pivot axes at the required locations. A portion of stationary plate 11 is likewise formed into the knuckles of pin-and-knuckle pivots 30a and 31 (see FIG. 3), the axes of which (32ax and 33x) are parallel and separated by a distance b as illustrated in FIG. 11. In the embodiment shown, a third pin-and-knuckle pivot 30b is present.

The pivot axes 12ax and 15x preferably lie in a plane that is parallel to swinging plate 10. In the embodiment shown in the drawings, these planes are also parallel to the plane of the door, which is fixed to the swinging plate.

Short linkage arms 20a and 20b, and long linkage arm 21 each have knuckles formed into a first end, here designated the “door plate end” for clarity, which are complimentary to the knuckles formed into plate 10. The linkage arm door plate end knuckles and the swinging plate knuckles are interleaved and rotatably connected with pivot pins, forming pin-and-knuckle pivots 22 and 23, respectively. Pivots 22 are preferably rotatable through an angle of 180°, which carries swinging plate 10 through both a 90° rotation and, simultaneously, a translation relative to stationary plate 11. (Compare FIG. 1 to FIG. 6.) In the course of this rotation/translation, the long and short linkage arms move in coordination, but along different paths. As a result, pivot 23 needs to rotate somewhat less than 180° due to the simultaneous displacement of pivot pin 15. In the example shown in the drawings, pivot 23 will rotate through about 173°.

FIGS. 3 and 4 show two views of the same hinge, in an approximately half-open configuration. The short linkage arms 20a and 20b, and long linkage arm 21, each have knuckles formed into their second end (the “stationary plate end”), complimentary to knuckles formed into stationary plate 11. The linkage arm stationary plate end knuckles, and the stationary plate knuckles, are interleaved and rotatably connected with pivot pins 32a/32b and 33, respectively, forming pin-and-knuckle pivots 30a/30b and 31. In this embodiment, pin-and-knuckle pivots 30a and 30b are rotatable through an angle of at least 90°, while the pin-and-knuckle pivot 31 may be rotatable through a lesser angle. Pivot pin 33 passes through the full width the plate 11, and through the knuckle of linkage arm 21.

FIGS. 5 and 6 show two views of the same hinge, in its fully-open configuration. Swinging plate 10 is now parallel to the wall, and will have carried the attached door to the same position. FIGS. 7, 8 and 9 are a top view of a door 40 attached to a hinge 1 of the invention. In FIG. 7, the door is closed, and spans the distance between the jambs 41 and 42 of a door frame, with the hinge 1 mounted on jamb 41. In most cases, there will be two or more hinges, one above the other, at intervals along the height of the door, as is common in the art of interior construction. FIG. 8 shows the door 40 partially open. It can be seen that the as the door rotates, the hinge 1 pulls the door toward the jamb 41. FIG. 9 shows the door 40 fully open, having been pulled perpendicular to, and almost entirely out of, the door opening.

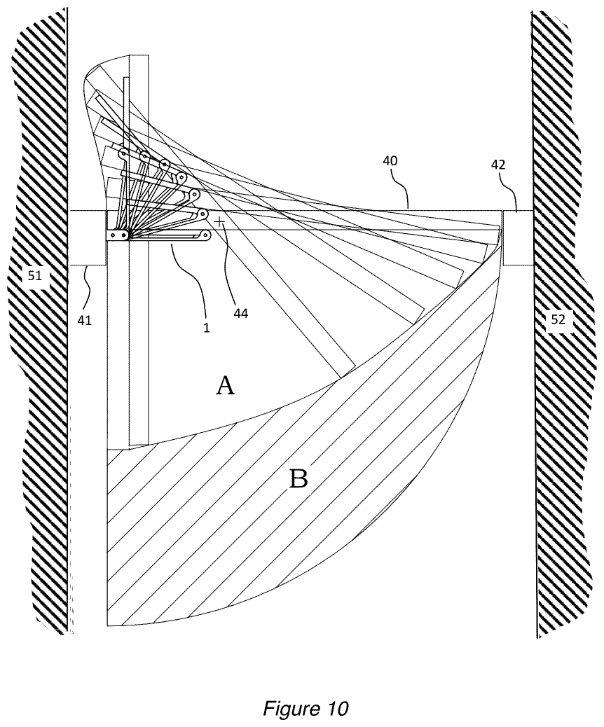

FIG. 10 illustrates an advantage of the hinge of the invention. Door jambs 41 and 42 are shown installed in a hallway between walls 51 and 52. Door 40 is mounted to jamb 41 via a hinge 1 of the invention. The positions of the door and hinge are shown at seven different stages of operation, from fully closed to fully open, in superimposed line drawings. It can be seen that the door sweeps out the area “A” in the course of opening the door. A conventional door of the same size, mounted to jamb 41 on conventional hinges, would swing in an arc, sweeping out the areas “A” and “B”. Thus, the invention makes available area “B” for persons and any objects or wheeled conveyances that they may have in their possession. Persons confined to wheelchairs, or pushing carts or strollers, will find it easier to open and pass through doors mounted on the hinges of the invention. Furthermore, the portion of wall 51 that borders on area “B” is made available for furniture, bookshelves, and the like. It can be seen that the hinge has a very low profile on the door, and that the hinge can readily be inset into a recess so as to have no profile of its own.

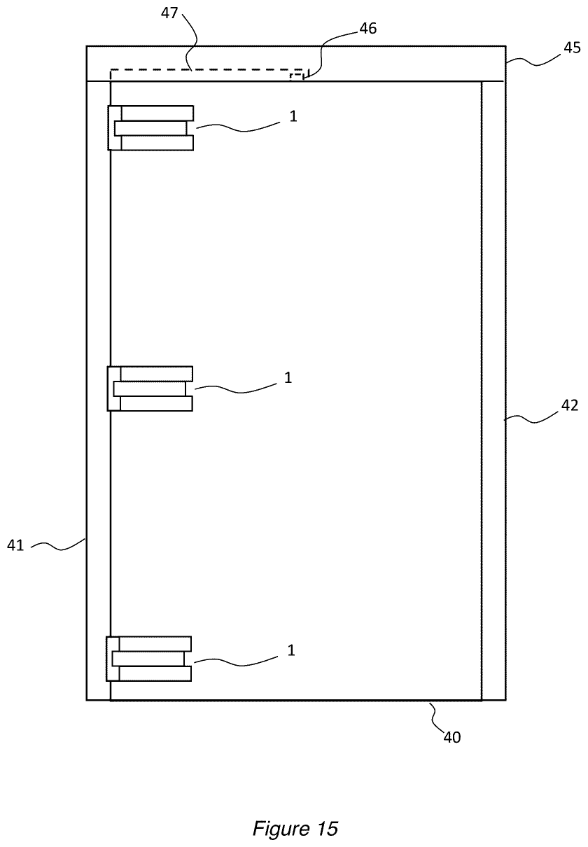

The point marked 44 in FIG. 10 is the approximate location where an optional guide pin 46 (see FIG. 15) may be installed in the top and/or bottom of the door. Each such guide pin rides in a guide track as discussed further below.

FIG. 11 shows the hinge 1 in a side view, with the axis-to-axis distances x, y, a and b indicated. These are the values that must, together, satisfy both Equation 1 and 2 Equation 2, as discussed above.

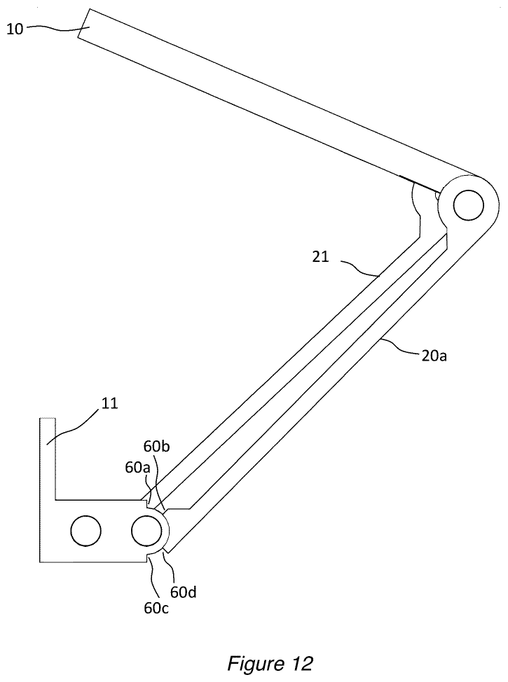

FIG. 12 shows a variation on this embodiment, featuring stops 60a-d that prevent over-rotation and consequent binding of the hinge. Similar stops may be placed at any of the pivots.

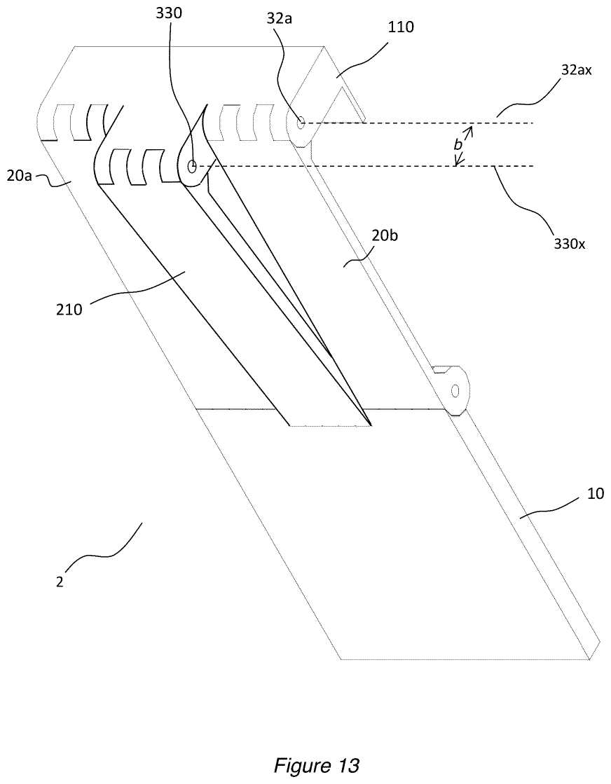

FIG. 13 shows an alternative embodiment 2 of the invention shown in FIG. 11, in which the hinge pin 330 of long linkage arm 210 is located further from the stationary plate 110 than pin 32a, their respective pivot axes 32ax and 330x being parallel and separated by a distance b. In this embodiment, when in the open configuration as shown, the linkage arm 210 supports the swinging plate from the opposite side of the hinge. A door supported by this embodiment, and fixed to swinging plate 10, will need to avoid obstructing the relative motion of linkage arm 210, for example by having a recess that accommodates linkage arm 210 when the door is opened. In order to be capable of the desired 90° rotation, the dimensions a, b, x and y should satisfy Equations 1 and 2 above, or they may satisfy the following equivalent equations:

a=(x+b−x cos(sin⁻¹(b/x)))/2 (Eqn. 3)

y=x−a+b (Eqn. 4)

As in the first embodiment, fixing any two of the variables establishes the values of the other two. For example, given x=8 inches and b=1 inch, y will be 8.4686 inches and a will be 0.5314 inches.

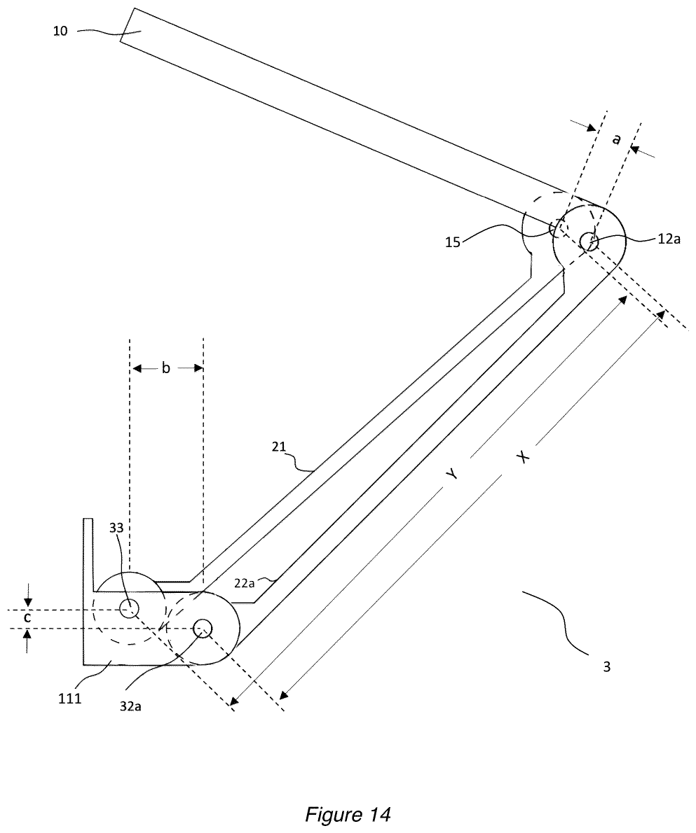

FIG. 14 shows a third embodiment 3 of the invention, similar to that of FIG. 11, where a small perpendicular offset distance c has been introduced between pin 32a and pin 33 in stationary plate 111. When this hinge is in the closed position, the offset maintains the long linkage arm 21 out of the plane of the short linkage arms. As a result, hinge pin 33 is not directly behind pin 32a, and when opening is initiated, the tension on long linkage arm 21 more easily induces the desired rotation around pivot axis 32ax, which is necessary for the motion of the hinge toward the open position. This reduces the chance of binding of the hinge when swinging plate 10 is rotated out of the closed position without being given a simultaneous translational motion.

In the design illustrated in FIG. 14, for a hinge capable of a 90° rotation of the swinging plate relative to the fixed plate, the following equations must be satisfied:

a=(bx+cx)/(2x+b−c) (Eqn. 5)

y=(b²+(x+a−c)²)^{1/2} (Eqn. 6)

So long as the dimensions a, b, c, x and y, as shown in FIG. 14, satisfy the above formulas, a hinge of the invention, constructed with those dimensions, will satisfactorily open and close over a range of 90°. Selection of any three of these dimensions establishes the values for the other two. By way of example, given a length x of the short linkage arm of 8.000 inches, a distance b between the axes of 1.000 inch, and an axis offset c of 0.25 inch, then the length y of the long linkage arm should be 8.4067 inches and the distance a should be 0.5970 inches.

It will be appreciated that a perpendicular offset feature can be employed to modify the embodiment of FIG. 13 as well, so as to bias the pivots toward the desired direction of rotation and prevent binding.

In practice, when two or more hinges of the invention are used to hang a door, they do not have their pivot axes locked in a co-axial arrangement, as is the case with conventional hinges, and as a result each hinge can, to some extent, operate independently of the others, allowing extraneous rotational motions of the door. In situations where extraneous door motions are unacceptable, the installation of a guide track 47 in the header 45, as shown in FIG. 15, may be desirable, to constrain the motion of a guide pin 46. Ideally, a curved track that precisely follows the motion of the door, as shown in FIG. 10, would be employed, but it has surprisingly been found that when the tracking pins are roughly in the center of the door's upper and/or lower edges (e.g., location 44 in FIG. 10), linear tracks are fully capable of guiding the door's motion. Preferably, for maximum control, guide pins are present in the top and bottom of the door, and a second track is installed in the sill or floor. Unlike conventional co-axial hinges, the hinges of the invention evidently can accommodate such deviations from the mathematically expected door motion.

In summary, and with reference to the drawings, the invention provides a first embodiment (1) of a hinge, comprising:
a) a first plate (11), having first (30a) and second (31) pivoting means disposed along an edge thereof, the first and second pivoting means having respectively first (33x) and second (32ax) pivot axes which are parallel and not co-axial and are separated by a distance b;
b) a second plate (10), having third (23) and fourth (22a) pivoting means disposed along an edge thereof, the third and fourth pivoting means having respectively third (15x) and fourth (12ax) pivot axes which are parallel and not co-axial and are separated by a distance a;
c) at least one long linkage arm (21) having fifth and sixth pivoting means at each end, the fifth and sixth pivoting means having respectively fifth (33x) and sixth (15x) pivot axes which are parallel and separated by a length y; and
d) at least one short linkage arm (20a) having seventh and eighth pivoting means at each end, the seventh and eighth pivoting means having respectively seventh (32ax) and eighth (12ax) pivot axes, the pivot axes being parallel and being separated by a length x.

The first (33x) and second (32ax) pivot axes together define a first plane, while the third (15x) and fourth (12ax) pivot axes together define a second plane. The first pivoting means of the first plate rotatably engages the fifth pivoting means of the long linkage arm, so that the first and fifth pivot axes are co-axial and constitute a single pivot axis (33x), and the second pivoting means of the first plate rotatably engages the seventh pivoting means of the short linkage arm, so that the second and seventh pivot axes are co-axial and constitute a single pivot axis (32ax). The third pivoting means of the second plate rotatably engages the sixth pivoting means of the long linkage arm, so that the third and sixth pivot axes are co-axial and constitute a single pivot axis (15x), and the fourth pivoting means of the second plate rotatably engages the eighth pivoting means of the long linkage arm, so that the fourth and eighth pivot axes are co-axial and constitute a single pivot axis (12ax).

Provided that the values of a, b, x and y simultaneously satisfy the following two equations

a=(y cos(sin⁻¹(b/y))−(y−b))/2 (1)

x=(y−b)+a (2),

this embodiment of the hinge is capable of transitioning between
(i) a closed state, in which all of the pivot axes lie in the first plane, within which the line defined by the second pivot axis (32ax) lies between the lines defined by the first (33x) and third (15x) pivot axes; and
(ii) an open state, in which the second, third, fourth, sixth, seventh, and eighth pivot axes lie in the second plane, the second plane is perpendicular to the first plane, and the first pivot axis (33x) defines a line that is parallel to the second plane and separated therefrom by the distance b.

In a second embodiment (2), the stationary plate (110) is modified so that, when the hinge (2) is in the closed state, the line defined by the first pivot axis (33x) lies between the lines defined by the second (32ax) and third (15x) pivot axes.

The invention also provides a third embodiment, comprising:
a) a first plate (111), having first and second pivoting means disposed along an edge thereof, the first and second pivoting means having respectively first (33) and second (32a) pivot axes which are parallel and not co-axial and are separated by a distance d;
b) a second plate (10), having third and fourth pivoting means disposed along an edge thereof, the third and fourth pivoting means having respectively third (15x) and fourth (12ax) pivot axes which are parallel and not co-axial and are separated by a distance a;
c) at least one long linkage arm (21) having fifth and sixth pivoting means at each end, the fifth and sixth pivoting means having respectively fifth (33x) and sixth (15x) pivot axes which are parallel and separated by a length y; and
d) at least one short linkage arm (22a) having seventh and eighth pivoting means at each end, the seventh and eighth pivoting means having respectively seventh (32ax) and eighth (12ax) pivot axes which are parallel and separated by a length x;

The third and fourth pivot axes together define a first plane, wherein the first pivoting means of the first plate rotatably engage the fifth pivoting means of the long linkage arm, so that the first and fifth pivot axes are co-axial and constitute a single pivot axis (33x); the second pivoting means of the first plate rotatably engage the seventh pivoting means of the short linkage arm, so that the second and seventh pivot axes are co-axial and constitute a single pivot axis (32ax); the third pivoting means of the second plate rotatably engage the sixth pivoting means of the long linkage arm, so that the third and sixth pivot axes are co-axial and constitute a single pivot axis (15x); and the fourth pivoting means of the second plate rotatably engage the eighth pivoting means of the long linkage arm, so that the fourth and eighth pivot axes are co-axial and constitute a single pivot axis (12ax).

When the hinge is in a closed state, the second, third, fourth, sixth, seventh, and eighth pivot axes lie in the first plane, and the line defined by the first pivot axis (33x) is parallel to the first plane and separated by a distance c therefrom. The lengths of b, c, and d form a right triangle, so that b²+c²=d².

The hinge is capable of transitioning from the closed state to an open state, in which the second, third, fourth, sixth, seventh, and eighth pivot axes lie in the first plane, and the first pivot axis (33x) defines a line that is parallel to the first plane and separated therefrom by a distance b, provided that the values of a, b, x and y simultaneously satisfy the following equations:

a=(bx+cx)/(2x+b−c) (5)

y=(b²+(x+a−c)²)^{1/2} (6).

As shown in FIG. 15, the invention also provides a door (40), having at least one guide pin (46), mounted within a door frame comprising two vertical jambs (41 and 42) and a header (45), wherein the door is attached to a jamb via at least one hinge (1, 2, or 3) as described above, and the guide pin rides in a track (47) attached to or embedded within the header. An optional second guide pin, riding within a second track, may be present at the bottom of the door.

I claim:

1. A hinge, comprising:
a) a first plate, having first and second pivoting means disposed along an edge thereof, the first and second pivoting means having respectively first and second pivot axes which are parallel and not co-axial and are separated by a distance b;
b) a second plate, having third and fourth pivoting means disposed along an edge thereof, the third and fourth pivoting means having respectively third and fourth pivot axes which are parallel and not co-axial and are separated by a distance a;
c) at least one long linkage arm having fifth and sixth pivoting means at each end, the fifth and sixth pivoting means having respectively fifth and sixth pivot axes which are parallel and separated by a length y; and
d) at least one short linkage arm having seventh and eighth pivoting means at each end, the seventh and eighth pivoting means having respectively seventh and eighth pivot axes, the pivot axes being parallel and being separated by a length x;
wherein the first and second pivot axes together define a first plane;
wherein the third and fourth pivot axes together define a second plane;
wherein the first pivoting means of the first plate rotatably engage the fifth pivoting means of the long linkage arm, so that the first and fifth pivot axes are co-axial;
wherein the second pivoting means of the first plate rotatably engage the seventh pivoting means of the short linkage arm, so that the second and seventh pivot axes are co-axial;
wherein the third pivoting means of the second plate rotatably engage the sixth pivoting means of the long linkage arm, so that the third and sixth pivot axes are co-axial;
wherein the fourth pivoting means of the second plate rotatably engage the eighth pivoting means of the long linkage arm, so that the fourth and eighth pivot axes are co-axial; and
wherein the values of a, b, x and y simultaneously satisfy the following two equations
a=(y cos(sin⁻¹(b/y))−(y−b))/2 (1)
x=(y−b)+a (2);
whereby the hinge is capable of transitioning between
(i) a closed state, in which all of the pivot axes lie in the first plane, within which the line defined by the second and seventh pivot axes lies between the lines defined by the first and third pivot axes; and
(ii) an open state, in which the second, third, fourth, sixth, seventh, and eighth pivot axes lie in the second plane, the second plane is perpendicular to the first plane, and the first and fifth pivot axes define a line that is parallel to the second plane and separated therefrom by the distance b.

2. The hinge according to claim 1, wherein the pivoting means are pin-and-knuckle hinges.

3. The hinge according to claim 2, wherein the plates and their respective knuckles are formed as monolithic objects.

4. The hinge according to claim 2, wherein the linkage arms and their respective knuckles are formed as monolithic objects.

5. The hinge according to claim 1, wherein one or more of the pivoting means are spring-loaded hinges.

6. The hinge according to claim 1, wherein the second plate is a planar plate, the plane of which is parallel to the second plane.

7. A hinge, comprising:
a) a first plate, having first and second pivoting means disposed along an edge thereof, the first and second pivoting means having respectively first and second pivot axes which are parallel and not co-axial and are separated by a distance b;
b) a second plate, having third and fourth pivoting means disposed along an edge thereof, the third and fourth pivoting means having respectively third and fourth pivot axes which are parallel and not co-axial and are separated by a distance a;
c) at least one long linkage arm having fifth and sixth pivoting means at each end, the fifth and sixth pivoting means having respectively fifth and sixth pivot axes which are parallel and separated by a length y; and
d) at least one short linkage arm having seventh and eighth pivoting means at each end, the seventh and eighth pivoting means having respectively seventh and eighth pivot axes, the pivot axes being parallel and being separated by a length x;
wherein the first and second pivot axes together define a first plane;
wherein the third and fourth pivot axes together define a second plane;
wherein the first pivoting means of the first plate rotatably engage the fifth pivoting means of the long linkage arm, so that the first and fifth pivot axes are co-axial;
wherein the second pivoting means of the first plate rotatably engage the seventh pivoting means of the short linkage arm, so that the second and seventh pivot axes are co-axial;
wherein the third pivoting means of the second plate rotatably engage the sixth pivoting means of the long linkage arm, so that the third and sixth pivot axes are co-axial;
wherein the fourth pivoting means of the second plate rotatably engage the eighth pivoting means of the long linkage arm, so that the fourth and eighth pivot axes are co-axial; and
wherein the values of a, b, x and y simultaneously satisfy the following two equations
a=(y cos(sin⁻¹(b/y))−(y−b))/2 (1)
x=(y−b)+a (2);
whereby the hinge is capable of transitioning between
(i) a closed state, in which all of the pivot axes lie in the first plane, within which the line defined by the first and fifth pivot axes lies between the lines defined by the second and third pivot axes; and
(ii) an open state, in which the second, third, fourth, sixth, seventh, and eighth pivot axes lie in the second plane, the second plane is perpendicular to the first plane, and the first and fifth pivot axes define a line that is parallel to the second plane and separated therefrom by the distance b.

8. The hinge according to claim 7, wherein the pivoting means are pin-and-knuckle hinges.

9. The hinge according to claim 8, wherein the plates and their respective knuckles are formed as monolithic objects.

10. The hinge according to claim 8, wherein the linkage arms and their respective knuckles are formed as monolithic objects.

11. The hinge according to claim 7, wherein one or more of the pivoting means are spring-loaded hinges.

12. The hinge according to claim 7, wherein the second plate is a planar plate, the plane of which is parallel to the second plane.

13. A hinge, comprising:
a) a first plate, having first and second pivoting means disposed along an edge thereof, the first and second pivoting means having respectively first and second pivot axes which are parallel and not co-axial and are separated by a distance d;
b) a second plate, having third and fourth pivoting means disposed along an edge thereof, the third and fourth pivoting means having respectively third and fourth pivot axes which are parallel and not co-axial and are separated by a distance a;
c) at least one long linkage arm having fifth and sixth pivoting means at each end, the fifth and sixth pivoting means having respectively fifth and sixth pivot axes which are parallel and separated by a length y; and
d) at least one short linkage arm having seventh and eighth pivoting means at each end, the seventh and eighth pivoting means having respectively seventh and eighth pivot axes, the pivot axes being parallel and being separated by a length x;
wherein the third and fourth pivot axes together define a first plane;
wherein the first pivoting means of the first plate rotatably engage the fifth pivoting means of the long linkage arm, so that the first and fifth pivot axes are co-axial;
wherein the second pivoting means of the first plate rotatably engage the seventh pivoting means of the short linkage arm, so that the second and seventh pivot axes are co-axial;
wherein the third pivoting means of the second plate rotatably engage the sixth pivoting means of the long linkage arm, so that the third and sixth pivot axes are co-axial;
wherein the fourth pivoting means of the second plate rotatably engage the eighth pivoting means of the long linkage arm, so that the fourth and eighth pivot axes are co-axial;
wherein, when the hinge is in a closed state, in which the second, third, fourth, sixth, seventh, and eighth pivot axes lie in the first plane, the line defined by the first and fifth pivot axes is parallel to the first plane and separated by a distance c therefrom;
wherein the hinge is capable of transitioning from the closed state to an open state, in which the second, third, fourth, sixth, seventh, and eighth pivot axes lie in the first plane, the second plane is perpendicular to the first plane, and the first and fifth pivot axes define a line that is parallel to the first plane and separated therefrom by a distance b; and
wherein the values of a, b, x and y simultaneously satisfy the following two equations
a=(bx+cx)/(2x+b−c) (1)
y=(b²+(x+a−c)²)1/2 (2).

14. The hinge according to claim 13, wherein the pivoting means are pin-and-knuckle hinges.

15. The hinge according to claim 14, wherein the plates and their respective knuckles are formed as monolithic objects.

16. The hinge according to claim 14, wherein the linkage arms and their respective knuckles are formed as monolithic objects.

17. The hinge according to claim 13, wherein one or more of the pivoting means are spring-loaded hinges.

18. The hinge according to claim 13, wherein the second plate is a planar plate, the plane of which is parallel to the first plane.

19. A door having a guide pin in its top edge, mounted within a door frame comprising two vertical jambs and a header, wherein the door is attached to a jamb via at least one hinge according to claim 1, and the guide pin rides in a track attached to or embedded within the header.

20. A door having a guide pin in its top edge, mounted within a door frame comprising two vertical jambs and a header, wherein the door is attached to a jamb via at least one hinge according to claim 7, and the guide pin rides in a track attached to or embedded within the header.

21. A door having a guide pin in its top edge, mounted within a door frame comprising two vertical jambs and a header, wherein the door is attached to a jamb via at least one hinge according to claim 13, and the guide pin rides in a track attached to or embedded within the header.
